(19) United States
(12) Patent Application Publication
(10) Pub. No.: US 2003/0225855 A1
(43) Pub. Date: Dec. 4, 2003

(54) Method and apparatus for realtime provision of related subject matter across internet content providers

(75) Inventors: Rick Allen Hamilton II, Charlottesville, VA (US); Steven Jay Lipton, Flower Mound, TX (US)

Correspondence Address: Rudolf. O Siegesmund, Suite 2000, 4627 N. Central Expressway, Dallas, TX, 75205-4017, US

(73) Assignee: International Business Machines Corporation, Armonk, NY (US)

(21) Appl. No.: 10/159,507

(22) Filed: May 30, 2002

(51) Int. Cl. G06F 15/16

(52) U.S. Cl. 709/217

(57) ABSTRACT

A method and apparatus is disclosed for generating and presenting relevant pages to the user at the desktop. A service such as the Internet Service Provider (ISP) receives updates of each web page requested by the user. The ISP provides an Interest Links Program (ILP) that scans the current page for terms contained in a term dictionary, defines interest items when matches are made between terms in the term dictionary and terms in the current page, and scans a content encyclopedia for matches with interest items. When a match is found, the ILP identifies an interest link and sends fast links to the desktop. On the desktop, a program lists and refreshes relevant links to the current page being considered by the user at any given time.

### FIELD OF THE INVENTION

This invention relates generally to retrieval and presentation of data from a distributed database such as the Internet. More particularly, it relates to a method of providing users with additional relevant subject matter when viewing web sites by means of links generated by a relevance service.

### BACKGROUND OF THE INVENTION

The distribution of content over the World Wide Web has fundamentally changed the way that people exchange information. Even as the revolution has taken place, companies and organizations have sought new ways to increase the efficiency of their own data transmission. Web pages, particularly those serving as news sources, sometimes list other web pages, which they have previously published on a given subject.

Additionally, the explosion of business models has led to many new and innovative ways of delivering heightened information to the desktop. U.S. Pat. No. 6,338,059, “Hyperlinked Search Interface for Distributed Database,” discloses real time creation of new hyperlinks in a hyperlinked database based on selected words in a search query. However, opportunities still remain for innovation in the delivery of content through Internet-based services, in a variety of ways. In other ways, additional mechanisms that will speed the delivery and efficiency of information germane to the user's interest still remain unexplored. Accordingly, new methods which accomplish this goal would be highly desirable.

Specifically, a need exists in two areas. First, on the server side, a need exists to perform real-time searches across content providers on pages relevant to the page currently loaded for a particular user. Secondly, on the client side, a need exists for a window with continuously updated pages, across content providers, germane to the page currently being viewed.

### SUMMARY OF THE INVENTION

The invention that meets the needs identified above is an apparatus and method for generating and presenting relevant pages to the user at the desktop. A service such as the Internet Service Provider (ISP) receives updates of each web page requested by the user. The ISP provides an Interest Links Program (ILP) that scans the current page for terms contained in a term dictionary, defines interest items when matches are made between terms in the term dictionary and terms in the current page, and scans a content encyclopedia for matches with interest items. When a match is found, the ILP identifies an interest link and sends fast links to the desktop. On the desktop, a program lists and refreshes relevant links to the current page being considered by the user at any given time.

### BRIEF DESCRIPTION OF THE DRAWINGS

FIG. 1 is an illustration of a distributed data network;

FIG. 2 is an illustration of a data processing system;

FIG. 3 is an illustration of a data processing system;

FIG. 4 depicts the server memory; and

FIG. 5 depicts a flow chart of the Interest Link Program (ILP).

### DETAILED DESCRIPTION OF THE PREFERRED EMBODIMENT

As used herein, the term “relevance service” means the entity that provides an Interest Links Program and includes without limitation the Internet Services Provider or any other third party. As used herein, the term “current page” means the last page loaded through the relevance service. As used herein, the term “desktop” shall mean a personal computer or a network computer that is connected to the Internet. As used herein, the term “term dictionary” means the set of words or phrases created and updated by the relevance service for the purpose of matching words or phrases on web pages. As used herein, the term “interest term” means a term from the term dictionary that is present in a given web page. As used herein, the term “content encyclopedia” is the listing of content providers, e.g. cnn.com, msnbc.com, espn.go.com, etc., that will be scanned for matching interest items. As used herein, the term “interest links” are those links from the content encyclopedia containing interest terms. As used herein, “fast link” means a visible link, removed form the clutter of a web page, that contains a direct link to a discovered page containing interest terms. As used herein, the term “contemplation time” is defined as the time spent by the user on a given web page. Contemplation time is the time available for determining and highlighting any interest links from the currently loaded page. Contemplation time is completed, by definition, when the next page is requested by the user.

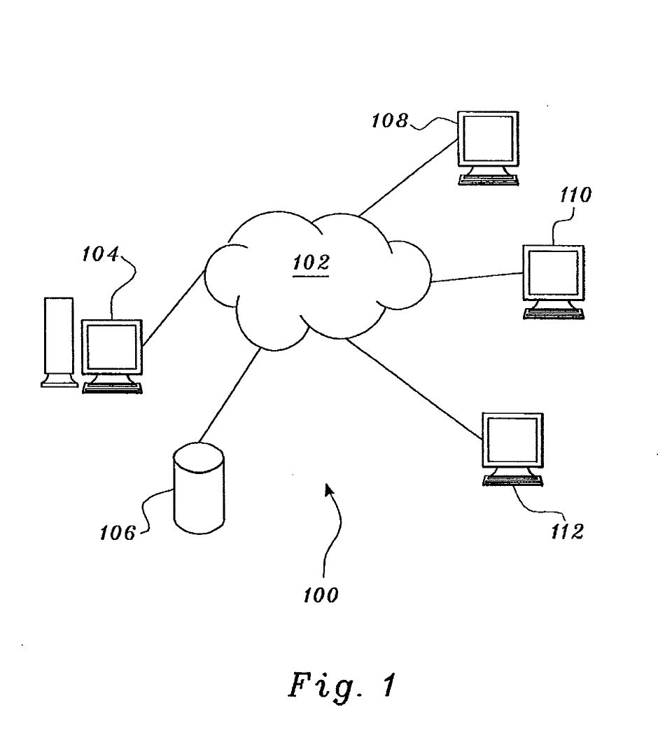

FIG. 1 depicts a pictorial representation of a distributed data processing system in which the present invention may be implemented and is intended as an example, and not as an architectural limitation, for the processes of the present invention. Distributed data processing system 100 is a network of computers which contains a network 102, which is the medium used to provide communication links between the various devices and computers connected together within distributed data processing system 100. Network 102 may include permanent connections, such as wire or fiber optic cables, or temporary connections made through telephone connections. In the depicted example, a server 104 is connected to network 102 along with storage unit 106. In addition, clients 108, 110, and 112 also are connected to a network 102. Clients 108, 110, and 112 may be, for example, personal computers or network computers.

For purposes of this application, a network computer is any computer, coupled to a network, which receives a program or other application from another computer coupled to the network. In the depicted example, server 104 provides Web based applications to clients 108, 110, and 112. Clients 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. Distributed data processing system 100 may also be implemented as a number of different types of networks, such as, an intranet, a local area network (LAN), or a wide area network (WAN).

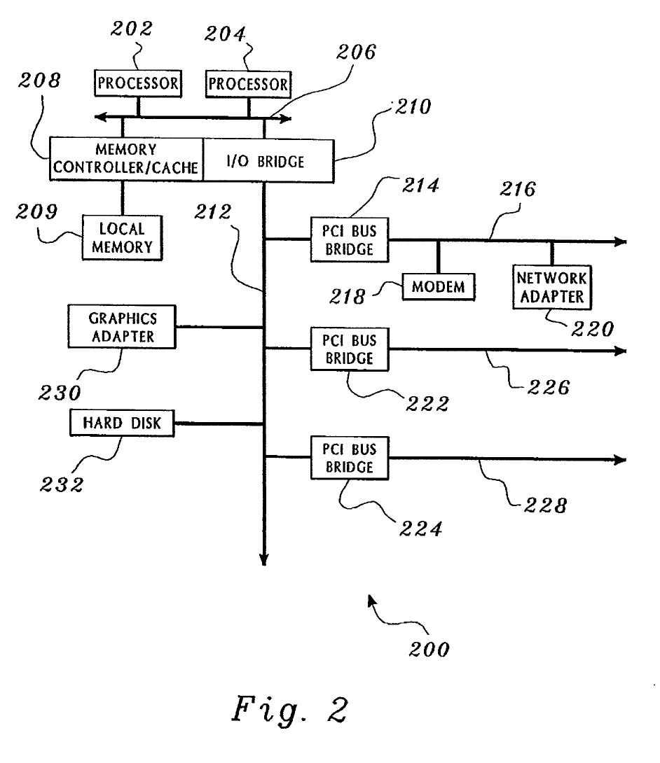

Referring to FIG. 2, a block diagram depicts a data processing system, which may be implemented as a server, such as server 104 in FIG. 1 in accordance with the present invention. Data processing system 200 may be a symmetric multiprocessor (SMP) system including a plurality of processors such as first processor 202 and second processor 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to first PCI local bus 216. Modem 218 may be connected to first PCI local bus 216. Typical PCI bus implementations will support four PCI expansion slots or add-in connectors. Communications links to clients 108, 110 and 112 in FIG. 1 may be provided through modem 218 and network adapter 220 connected to first PCI local bus 216 through add-in boards. Additional PCI bus bridges such as second PCI bus bridge 222 and third PCI bus bridge 224 provide interfaces for additional PCI local buses such as second PCI local bus 226 and third PCI local bus 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as an optical disk drive and the like also may be used in addition or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, N.Y., running the Advanced Interactive Executive (AIX) operating system.

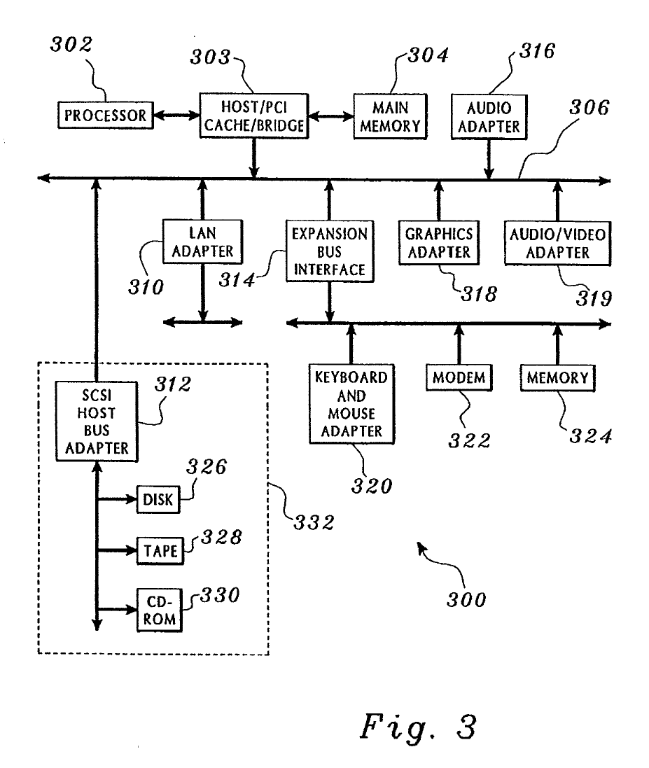

With reference now to FIG. 3, a block diagram illustrates a data processing system in which the invention may be implemented. Data processing system 300 is an example of either a stand-alone computer, if not connected to distributed data processing system 100, or a client computer, if connected to distributed data processing system 100. Data processing system 300 employs a peripheral component interconnect (PCI) local bus architecture. Although the depicted example employs a PCI bus, other bus architectures such as Micro Channel and ISA may be used. Processor 302 and main memory 304 are connected to PCI local bus 306 through PCI bridge 303. PCI bridge 303 also may include an integrated memory controller and cache memory for Processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM 330 in the depicted example. Typical PCI local bus implementations will support three or four PCI expansion slots or add-in connectors. An operating system runs on processor 302 and is used to coordinate and provide control of various components within data processing system 300 in FIG. 3. The operating system may be a commercially available operating system such as OS/2, which is available from International Business Machines Corporation. “OS/2” is a trademark of International Business Machines Corporation. An object oriented programming system, such as Java, may run in conjunction with the operating system and provides calls to the operating system from Java programs or applications executing on data processing system 300. “Java” is a trademark of Sun Microsystems, Incorporated. Instructions for the operating system, the object-oriented operating system, and applications or programs may be located on storage devices, such as hard disk drive 326, and they may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system. For example, data processing system 300, if configured as a network computer, may not include SCSI host bus adapter 312, hard disk drive 326, tape drive 328, and CD-ROM 330, as noted by the box with the dotted line in FIG. 3 denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide non-volatile memory for storing operating system files and/or student-generated data. The depicted example in FIG. 3 and above-described examples are not meant to imply architectural limitations with respect to the present invention. It is important to note that while the present invention has been described in the context of a fully functioning data processing system, those of ordinary skill in the art will appreciate that the processes of the present invention are capable of being distributed in a form of a computer readable medium of instructions and a variety of forms and that the present invention applies equally regardless of the particular type of signal bearing media actually used to carry out the distribution. Examples of computer readable media include recordable-type media, such a floppy disc, a hard disk drive, a RAM, and CD-ROMs, and transmission-type media, such as digital and analog communications links.

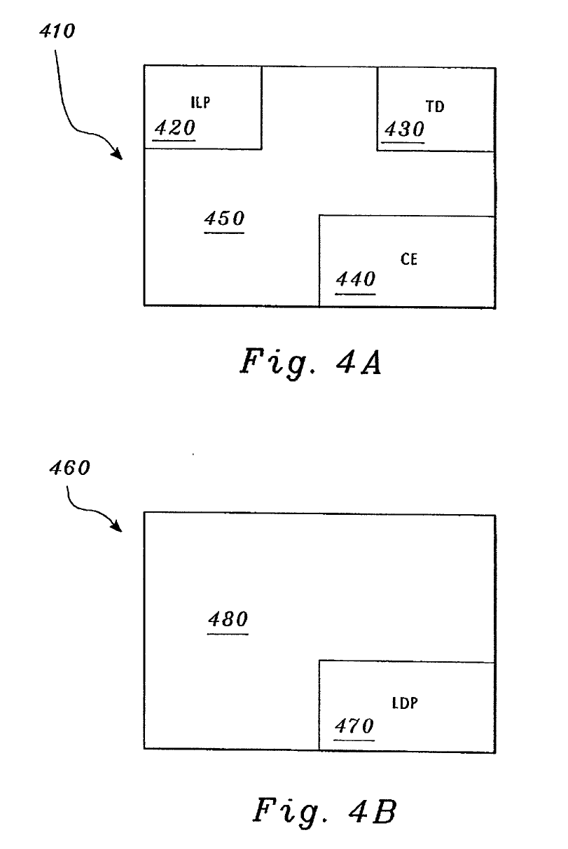

FIG. 4 depicts a representation of a server memory containing Interest Links Program (ILP) 420, server available memory 450, term dictionary 430 and content encyclopedia 440. FIG. 4B depicts a representation of desktop memory 460 containing desktop available memory 480 and a Link Display Program (LDP) 470.

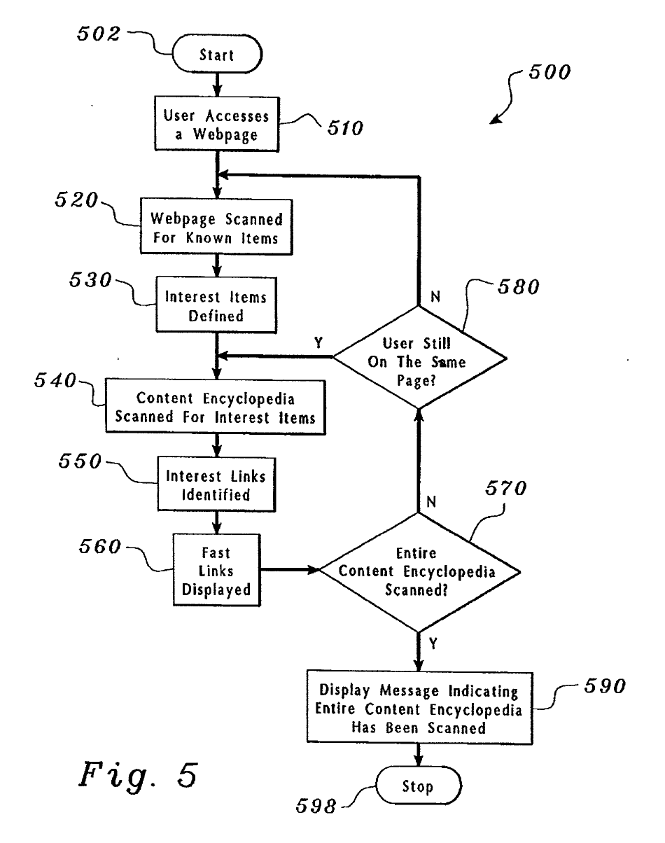

FIG. 5 depicts a flowchart of Interest Links Program (ILP) 500. ILP 500 begins (502). A user accesses a current page (510) through the relevance service providing ILP 500. ILP 500 scans the current page to find out what words or expressions from the term dictionary are present within the current page (520). Areas to be scanned in the current page include without limitation the header bar, metatags, text/page content, and hyperlinks. From this scan activity, interest items are defined by matches made between terms from the term dictionary and terms in the current page and a list of interest items is derived (530). Next, ILP 500 scans the content encyclopedia to determine if the words or expressions in the interest item list are contained in a page from the content encyclopedia (540). If an interest item is found in the content encyclopedia, then an interest link is created (550). Next, fast links are created to the interest links (550) and displayed at the desktop (560). As fast links are discovered, they are sent to the desktop for receipt either by a browser extension or a receiving application on the user machine such as LDP 470 (See FIG. 4). A determination is made as to whether or not the entire content encyclopedia has been scanned (570). If the entire content encyclopedia has been scanned, a message is displayed indicating that the entire content encyclopedia has been scanned (590) and ILP 500 ends (598). If the entire content encyclopedia has not been scanned, a determination is made as to whether contemplation time has been completed (580). If contemplation time has not been completed, ILP 500 goes to step 540. If the contemplation time has been completed, ILP 500 goes to step 520.

At the desktop, LDP 470 creates a persistent window with fast links created by ILP 500 displayed as available. When a user loads a current page, the persistent window accompanying the current page would either be blank, or have a display message such as “search underway.” As fast links are determined by ILP 500, the persistent window displays the fast links, as they are presented to the desktop. The persistent window may see fast links populated for the duration of the contemplation time, or until the server exhausts the content encyclopedia. Alternatively, fast links may be displayed by a pull-down bar.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method of providing related subject matter across Internet Service Providers comprising:
establishing a term dictionary; and
establishing a content encyclopedia.

2. The method of claim 1 further comprising the step of:
determining an interest item by matching a term in the term dictionary with a current page term.

3. The method of claim 2 further comprising the step of:
determining whether the interest item is contained in the content encyclopedia.

4. The method of claim 3 further comprising the step of:
responsive to determining that the interest item is contained in the content encyclopedia, identifying an interest link.

5. The method of claim 4 further comprising the step of:
displaying a fast link in a persistent window.

6. The method of claim 4 further comprising the step of:
displaying a fast link in a pull down bar.

7. A method of creating an interest link comprising:
establishing a term dictionary;
establishing a content encyclopedia; and
determining whether a term is contained in both the term dictionary and the content encyclopedia.

8. The method of claim 7 further comprising the step of:
responsive to determining that a term is contained in both the term dictionary and the content encyclopedia, identifying an interest link.

9. The method of claim 8 further comprising the step of:
displaying a fast link in a persistent window.

10. The method of claim 8 further comprising the step of:
displaying a fast link in a pull down bar.

11. An apparatus for providing related subject matter across Internet Service Providers comprising:
programmable hardware;
software;
said programmable hardware being directed by said software to perform steps comprising:
establishing a term dictionary; and
establishing a content encyclopedia.

12. The apparatus of claim 11 wherein said programmable hardware is further directed to perform the step of determining an interest item.

13. The apparatus of claim 12 wherein said programmable hardware is further directed to perform the step of determining whether the interest item is contained in the content encyclopedia.

14. The apparatus of claim 13 wherein said programmable hardware is further directed to perform the step of, responsive to determining that the interest item is contained in the content encyclopedia, identifying an interest link.

15. The apparatus of claim 14 wherein said programmable hardware is further directed to perform the step of:
displaying a fast link in a persistent window.

16. The apparatus of claim 14 wherein said programmable hardware is further directed to perform the step of:
displaying a fast link in a pull down bar.

17. An apparatus for providing related subject matter across Internet Service Providers comprising:
a first computer connected to the Internet;
a memory in the first computer having an Interest Links Program, a term dictionary for a second computer, and a content encyclopedia;
the second computer connected to said first computer by the Internet;
wherein, responsive to said first computer identifying an interest item, said first computer causes an fast link to be displayed on said second computer.

18. The apparatus of claim 17 wherein, responsive to said first computer identifying an interest item, an interest link is identified.

19. The apparatus of claim 17 wherein said fast link is displayed in a persistent window.

20. The apparatus of claim 17 wherein said fast link is displayed in a pull down bar.

21. An apparatus for providing related subject matter across Internet Service Providers between a first computer and a second computer connected by the Internet comprising:
in the first computer, means for establishing a term dictionary;
in the first computer, means for establishing a content encyclopedia;
in the first computer, means for determining an interest item; and
in the first computer, means for identifying an interest link.

22. The apparatus of claim 21 further comprising:
in the second computer, means for displaying a fast link to said interest link.

23. The apparatus of claim 22 further comprising:
means for displaying the fast link in a persistent window.

24. The apparatus of claim 22 further comprising:
means for displaying the fast link in a pull down bar.
